(19) United States
(12) Patent Application Publication
(10) Pub. No.: US 2021/0317250 A1
(43) Pub. Date: Oct. 14, 2021

(54) RADIATION-CURABLE AQUEOUS POLYURETHANE DISPERSIONS

(71) Applicant: DSM IP ASSETS B.V., Heerlen (NL)

(72) Inventors: Ilse VAN DER HOEVEN-VAN CASTEREN, Echt (NL); Josephus Christiaan VAN OORSCHOT, Echt (NL); Ronald TENNEBROEK, Echt (NL); Gerardus Cornelis OVERBEEK, Echt (NL); Harmanna HENDERIKS, Echt (NL)

(21) Appl. No.: 17/258,964

(22) PCT Filed: Jul. 9, 2019
(86) PCT No.: PCT/EP2019/068449

§ 371 Date: Jan. 8, 2021

(30) Foreign Application Priority Data
Jul. 10, 2018 (EP) 18182761.9

(51) Int. Cl. C08G 18/10; C09D 11/101; C08G 18/34; C08G 18/38; C09D 11/102; C09D 11/38; C08G 18/48

(52) U.S. Cl. CPC C08G 18/10; C09D 11/101; C08G 18/348; C08G 18/4854; C09D 11/102; C09D 11/38; C08G 18/3825

(57) ABSTRACT

The present invention is directed to radiation-curable aqueous polyurethane dispersion, wherein the dispersion comprises aniomcally stabilized polyurethane A present in disperse form; and wherein said polyurethane A comprises 5 (meth)acrylamide functional groups in an amount of at least 0.2 mmol per g of the polyurethane A.

The present invention relates to the field of radiation-curable aqueous polyurethane dispersions.

Radiation-curable aqueous polyurethane dispersions (PUDs) are widely used to produce materials such as coatings, inks and/or adhesives that are cured by radiation. Such radiation cured coatings exhibit very good properties on numerous substrates like wood, plastic, concrete, metal, glass and/or textiles. The advantage of aqueous polyurethane dispersions compared to 100% radiation-curable compositions (containing radiation-curable diluents, but no water) is that low viscosities can be achieved without large amounts of radiation-curable diluents. The viscosity of 100% radiation-curable compositions can be reduced using increased temperature, but still the presence of radiation-curable diluents will be required. When applying a coating, ink or adhesive composition, a high viscosity of the composition is undesired since it will require more effort to apply the coating, ink or adhesive composition. On the other hand, high amounts of radiation-curable diluents are disadvantageous as handling of the coating, ink or adhesive composition during application of the coating, ink or adhesive composition on the substrate is more cumbersome since unreacted compounds are present in the coating, ink or adhesive composition, which can cause skin irritation. Furthermore, the films from 100% radiation-curable compositions are still liquid before cure and the cured coating, ink or adhesive may still contain low molecular weight non-reacted material which can migrate from the coating, ink or adhesive (so-called migratables) which is not desired in for example food contact applications and for indoor air quality.

The present invention is directed to radiation-curable aqueous polyurethane dispersions as for example described in WO-A-03046095. After evaporation of water, the composition is cured by irradiation with for example UV light resulting in a crosslinked composition with in general very good chemical and mechanical resistances. In order to make the polyurethane radiation-curable (meth)acryloyl functional groups are chemically incorporated into the polyurethane. Suitable compounds for this purpose are compounds having at least one unsaturated function such as acrylic or methacrylic groups and at least one nucleophilic function capable of reacting with isocyanates. Particularly suitable are the acrylic or methacrylic esters of polyols, in which at least one hydroxy functionality remains free for being capable of reacting with isocyanates. Thus, in general the chemical incorporation of (meth)acryloyl functional groups into the polyurethane is done by incorporating hydroxyl functional acrylesters or methacrylesters. Widely used monounsaturated compounds are hydroxyethylacrylate, hydroxypropylacrylate and hydroxybutylacrylate. Examples of polyunsaturated compounds are trimethylolpropane diacrylates, pentaerythritol triacrylate, ditrimethylolpropane triacrylate and their polyethoxylated and polypropoxylated equivalents, and epoxy acrylates such as for example bisphenol A diglycidylether diacrylate.

A disadvantage of such radiation-curable aqueous polyurethane dispersions whereby the chemical incorporation of (meth)acryloyl functional groups into the polyurethane is done by incorporating hydroxyl functional acrylesters or methacrylesters, is that the particle size of the dispersed particles may increase over time (thus during storage) resulting in potential agglomeration of the particles resulting in potential sedimentation and thus a poor resistance to phase separation and thus poor long-term storage stability.

In addition, the viscosity of for example a paint strongly depends on the particle size of the original dispersion. A thickener will become more effective when the particle size is small, due to a greater surface area. Further, when particle size increases over time, the viscosity of the formulation may change as well. As a result, paint producers have to adjust their formulation depending on the age of the dispersion which is undesirable. Furthermore, the final formulation has limited storage stability. In addition, the increase in particle size of the dispersed polyurethane particles may cause problems during the application of inks because of for example blocking of the nozzles of the print heads in inkjet ink printers and consequently interruption of the printing process. Furthermore, particle size and viscosity affect drop size and drop velocity of the printing ink. Changing particle size in time will thus influence printing accuracy. To circumvent these problems of productivity and reliability, the ink must have a stable particle size.

The object of the present invention is to provide radiation-curable aqueous polyurethane dispersions whereby the increase of the average particle size over time is less compared to radiation-curable aqueous polyurethane dispersions whereby the chemical incorporation of radiation-curable (meth)acryloyl functional groups into the polyurethane is done by incorporating hydroxyl functional acrylesters or methacrylesters.

The object of the present invention has surprisingly been achieved by providing a radiation-curable aqueous polyurethane dispersion, wherein the dispersion comprises anionically stabilized polyurethane A present in disperse form; and wherein said polyurethane A comprises (meth)acryloyl amide functional groups in an amount of at least 0.2 mmol per g of the polyurethane.

It has surprisingly been found that the dispersions according to the invention have excellent particle size stability. It has surprisingly been found that the increase of the average particle size is significantly reduced when at least a part of the radiation-curable (meth)acryloyl functional groups are incorporated into the polyurethane by incorporating hydroxyl functional (meth)acrylamides instead of hydroxyl functional (meth)acrylesters. The increase of the average particle size over 7 days, more preferably over 14 days, most preferred over 28 days of the dispersion when stored at 60° C. can surprisingly be reduced to less than 50%, preferably to less than 40% and more preferably to less than 30%, whereby the starting point to calculate the increase of the average particle size is the dispersion that has been stored for 1 day at room temperature (22±2° C.). An additional advantage of the present invention is that the viscosity stability over time of the radiation-curable aqueous polyurethane dispersion is improved when at least a part of the radiation-curable (meth)acryloyl functional groups are incorporated into the polyurethane by incorporating hydroxyl functional (meth)acrylamides instead of hydroxyl functional (meth)acrylesters. Viscosity variation can have a profound effect on the performance of the formulated dispersion in the final application, e.g. in painting and even more in inkjet printing. Viscosity stability of an ink-jet formulation is very important because a small change in viscosity may have an impact on drop size and drop velocity of the jettet ink drop, which may result in a change in pixel size and location of the pixel. The change in viscosity at a solids level of at least 20 wt. % over 7 days, more preferably over 14 days, most preferred over 28 days of the dispersion of the present invention when stored at 60° C. can surprisingly be reduced to less than 25%, whereby the starting point to calculate the change in viscosity is the dispersion that has been stored for 1 day at 60° C. The solids content of the dispersion is determined by the method described in the experimental part herein below, which is by evaporation of the volatile compounds such as water and optionally solvent and volatile amines present in the dispersion. The viscosity and average particle size are determined by the method described in the experimental part herein below.

In a preferred embodiment of the invention, both the increase in average particle size and the change in viscosity at a solids level of at least 20 wt %, more preferably of at least 30 wt %, most preferably of at least 35 wt %, especially preferred of at least 40 wt % over 7 days, more preferably over 14 days, most preferably over 21 days, especially preferred over 28 days at room temperature (22±2° C.), more preferably at 30 degrees C., even more preferably at 40 degrees C., most preferably at 50 degrees C., especially preferred at 60 degrees C. can surprisingly be reduced to less than 30%, preferably to less than 20%, more preferably to less than 15%, and even more preferably to less than 10%, whereby the starting point to calculate the increase in average particle size and the change in viscosity is the dispersion that has been stored for 1 day at room temperature. The increase in average particle size at a solids level of at least 20 wt %, more preferably of at least 30 wt %, most preferably of at least 35 wt %, especially preferred of at least 40 wt % over 7 days, more preferably over 14 days, most preferably over 21 days, especially preferred over 28 days at room temperature, more preferably at 30 degrees C., even more preferably at 40 degrees C., most preferably at 50 degrees C., especially preferred at 60 degrees C. can surprisingly be reduced to less than 30 nm, preferably to less than 20 nm, more preferably to less than 10 nm, even more preferably to less than 5 nm, whereby the starting point to calculate the increase in average particle size is the dispersion that has been stored for 1 day at a given temperature. The change in viscosity at a solids level of at least 20 wt %, more preferably of at least 30 wt %, most preferably of at least 35 wt %, especially preferred of at least 40 wt % over 7 days, more preferably over 14 days, most preferably over 21 days, especially preferred over 28 days at room temperature, more preferably at 30 degrees C., even more preferably at 40 degrees C., most preferably at 50 degrees C., especially preferred at 60 degrees C. can surprisingly be reduced to less than 10 mPa·s, preferably to less than 5 mPa·s, more preferably to less than 2 mPa·s, even more preferably to less than 1 mPa·s, whereby the starting point to calculate the change in viscosity is the dispersion that has been stored for 1 day at a given temperature.

JP-A-2016027160 discloses radiation-curable aqueous polyurethane dispersions in which the polyurethane resin has no polymerizable unsaturated bond and the dispersion contains (meth)acryloyl morpholine and/or a hydroxyl group-containing (meth)acrylamide. The polyurethane resin is preferably obtained by reacting a polycarbonate polyol, an acidic group-containing polyol, a polyisocyanate compound, and a chain extender. The dispersion is radiation-curable through the (meth)acryloyl morpholine and/or a hydroxyl group-containing (meth)acrylamide added after polyurethane formation. The polyurethane has no polymerizable unsaturated bonds and hence is not radiation-curable. In example 5 the urethane prepolymer is first dispersed in water and then chain-extended with 2-methyl-1,5-pentanediamine. To the chain-extended polyurethane dispersion N-2-hydroxyethyl acrylamide was added. There is no reaction between the polyurethane and N-2-hydroxyethyl acrylamide and consequently the amount of acrylamide functional groups in the polyurethane is 0.

The aqueous dispersion according to the present invention is radiation-curable. By radiation-curable is meant that radiation is required to initiate crosslinking of the dispersion. Optionally a photoinitiator (PI) may be added to the radiation-curable aqueous dispersion of the invention to assist radiation curing, especially if curing is by UV radiation. However, if curing is to be achieved by, for example, electron beam (EB) then a PI may not be needed. Preferably, the radiation-curable aqueous dispersion of the invention comprises a photo-initiator and UV-radiation is applied to obtain a cured coating. Thus the aqueous dispersion is preferably UV radiation-curable.

The dispersion according to the invention contains ethylenically unsaturated (C═C) bond functionality which under the influence of irradiation (optionally in combination with the presence of a (photo)initiator) can undergo crosslinking by free radical polymerisation. It is especially preferred that this irradiation is UV irradiation.

The ethylenically unsaturated bond functionality concentration (also referred to as the C═C bond concentration) of the dispersion of the present invention is preferably in the range from 0.3 to 6 meq per g of the summed weight amount of polyurethane and optional radiation-curable diluent present in the dispersion of the invention, preferably in the range from 0.4 to 5, more preferably from 0.5 to 3.5, more preferably from 0.6 to 3.0, even more preferably from 0.7 to 2.5 meq per g of polyurethane and optional radiation-curable diluent. The radiation-curable C═C bonds are preferably chosen from (meth)acryloyl groups, most preferably acryloyl groups. In the present invention, at least a part of the (meth)acryloyl groups are introduced in the dispersion by incorporating (meth)acryloyl amide functional groups in the polyurethane. As used herein, the amount of C═C bonds present in the dispersion is determined by adding up all radiation-curable C═C functionality from the components used to prepare the dispersion. Hence, the amount of C═C bonds present in the dispersion represents the radiation-curable C═C bonds present in the polyurethane and radiation-curable diluent. As used herein, the expression per g of the polyurethane is determined by the total weight amount of components used to prepare the polyurethane from which the building blocks of the polyurethane are emanated.

The radiation-curable aqueous dispersion of the invention comprises radiation-curable polyurethane A in disperse form (i.e. the dispersion comprises dispersed particles of radiation-curable polyurethane A), wherein the polyurethane A is at least for a part anionically stabilised and wherein said polyurethane A comprises (meth)acryloyl amide functional groups in an amount of at least 0.2 mmol per g of the polyurethane. The amount of (meth)acryloyl amide functional groups present in the polyurethane A is at least 0.2 mmol per g of the polyurethane A, i.e. the summed amount of methacryloyl amide functional groups and acryloyl amide functional groups present in the polyurethane A is at least 0.2 mmol per g of the polyurethane A. The amount of (meth)acryloyl amide functional groups present in the polyurethane A is preferably at least 0.35 mmol per g of the polyurethane A, more preferably at least 0.5 mmol per g of the polyurethane A. The amount of (meth)acryloyl amide functional groups present in the polyurethane A is preferably at most 6 mmol per g of the polyurethane A, more preferably at most 4 mmol per g of the polyurethane A and most preferably at most 2.5 mmol per g of the polyurethane A.

Preferably, at least 50 mol % of the ethylenically unsaturated bond concentration of the polyurethane A, more preferably at least 70 mol %, even more preferably at least 75 mol %, even more preferably at least 90 mol % and most preferably 100 mol % of the ethylenically unsaturated bond concentration of the polyurethane A is present in the polyurethane A as (meth)acrylamide functional groups.

The polyurethane A preferably comprises acrylamide functional groups.

An acrylamide functional group has the following formula:

H₂C═C(C═O)NR—, whereby R is H or C.

A methacrylamide functional group has the following formula:

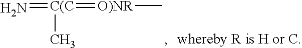

An acryloyl ester functional group has the following formula:

H₂C═C(C═O)O—

A methacryloyl ester functional group has the following formula:

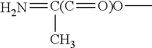

A dispersion refers to a two-phase system where one phase contains discrete particles (colloidally dispersed particles) distributed throughout a bulk substance, the particles being the disperse phase and the bulk substance the continuous phase or the dispersing medium. In the present invention, the continuous phase of the dispersion predominantly comprises water, but some amount of organic compounds such as for example organic liquids is allowed. This in contrast to organic solvent based dispersions in which organic solvent is the major part of the carrier fluid. Preferably the continuous phase of the dispersion of the invention comprises at least 75 wt. %, more preferably at least 85 wt. % of water (relative to the continuous phase).

In accordance with the present invention, the term “polyurethane dispersion” refers to dispersion of polymers containing urethane groups and optionally urea groups, further referred to as polyurethane(s). The dispersion of the invention comprises polyurethane in dispersed form at a pH of the aqueous dispersing medium of preferably >6, more preferably at a pH from 6 to 11, more preferably at a pH from 7 to 9, i.e. the dispersion comprises polyurethane particles with usually an average particle size ranging from 10 nm to 200 nm. These polymers also contain hydrophilic functionality to obtain a stable dispersion of the polyurethane in the aqueous dispersing medium.

In accordance with the present invention, the polyurethane A is stabilized in the dispersion at least through anionic functionality incorporated into the polyurethane A such as neutralized acid groups (“anionically stabilized polyurethane A dispersion”). Thus, the polyurethane A is at least for a part anionically hydrophilized by chemically incorporating anionic functional groups into the polyurethane A to provide at least a part of the hydrophilicity required to enable the polyurethane A to be stably dispersed in the aqueous dispersing medium. The anionic functionality, optionally in combination with non-ionic functionality, is capable to render the polyurethane A polymer dispersible in the aqueous dispersing medium either directly or after reaction with a neutralizing agent, also referred to as (potentially) anionic groups. The polyurethane A contains anionic functional groups preferably selected from the group consisting of carboxylate groups, sulfonate groups, phosphonate groups and any combination thereof. For example, sulfonate groups may be incorporated into the polyurethane A by using a sulfonate based compound, such as for example Vestamin A95, as chain extender after the prepolymer preparation. More preferably, the polyurethane A contains functional groups selected from the group consisting of carboxylic acid groups, sulfonic acid groups, phosphoric acid groups and any combination thereof, which become anionic when deprotonated. The deprotonation is usually obtained by neutralizing the corresponding acid groups suitably prior to, during or after formation of the polyurethane A prepolymer, more suitably after formation of the polyurethane A prepolymer. Most preferably, the polyurethane A contains carboxylic acid and/or sulfonic acid groups which become anionic when deprotonated. Preferably, the carboxylic acid groups are incorporated into the polyurethane A by chemically incorporation of a hydroxy-carboxylic acid(s) into the polyurethane A to provide after deprotonation at least a part of the hydrophilicity required to enable the polyurethane A to be stably dispersed in the aqueous dispersing medium. The hydroxy-carboxylic acid(s) is preferably a dihydroxy alkanoic acid(s), preferably α,α-dimethylolpropionic acid and/or α,α-dimethylolbutanoic acid. More preferably, the dihydroxy alkanoic acid(s) is α,α-dimethylolpropionic acid. Preferably, the sulfonate groups are incorporated into the polyurethane A by using a sulfonate based compound, such as for example Vestamin A95, as chain extender after the prepolymer preparation.

The neutralizing agent used to deprotonate (neutralize) the carboxylic acid groups, sulfonic acid groups and/or phosphoric acid groups is preferably selected from the group consisting of ammonia, a (tertiary) amine, a metal hydroxide and any mixture thereof. Suitable tertiary amines include triethylamine and N,N-dimethylethanolamine. Suitable metal hydroxides include alkali metal hydroxides, for example lithium hydroxide, sodium hydroxide and potassium hydroxide. Preferably, at least 30 mol %, more preferably at least 50 mol % and most preferably at least 70 mol % of the total molar amount of the neutralizing agent is alkali metal hydroxide, preferably selected from the group consisting of lithium hydroxide, sodium hydroxide, potassium hydroxide and any mixture thereof. Preferably the neutralizing agent used to deprotonate (neutralize) the carboxylic acid groups, sulfonic acid groups and/or phosphoric acid groups is an alkali metal hydroxide.

The negative charge on the anionically stabilized polyurethane A may further (partly since the stabilization of the polyurethane A is partly obtained through incorporated anionic functionality) be obtained by stabilizing the polyurethane A during or after polymerization by adding external surfactants. Preferably, the stabilization of the polyurethane A in the dispersion is not achieved by adding external (anionic) surfactants.

The polyurethane A may further be stabilized in the dispersion through non-ionic functionality incorporated into the polyurethane A. Thus, the polyurethane A may at least for a part be non-ionically stabilized by chemically incorporating non-ionic groups into the polyurethane A to provide at least a part of the hydrophilicity required to enable the polyurethane A to be stably dispersed in the aqueous dispersing medium. Preferred non-ionic water-dispersing groups are polyalkylene oxide groups such as polyethylene oxide and polypropylene oxide groups. Most preferred non-ionic water-dispersing groups are polyethylene oxide groups.

Preferably, the groups which are capable to render the polyurethane A dispersible in the aqueous dispersing medium are non-ionic groups in combination with anionic groups, which anionic groups are capable to render the polyurethane A polymer dispersible in the aqueous dispersing medium either directly or after reaction with a neutralizing agent. The polyurethane A is then stabilized in the dispersion through non-ionic and anionic functionality incorporated into the polyurethane A. Radiation-curable aqueous dispersions of the present invention in which the polyurethane A is stabilized in the dispersion through non-ionic and anionic functionality incorporated into the polyurethane A are in particular suitable for making inks. To circumvent problems of productivity and reliability during the application of ink, the ink must have a particular behavior often referred to as “resolubility” (sometimes called reversibility or redispersibility), meaning that a dry or drying polymer obtained from an aqueous polymer composition is redispersible or resolvable in that same composition when the latter is applied thereto. It has been found that an improved resolubility of the polymer can be obtained by also non-ionic stabilization of the polyurethane however this contributes to the disadvantage of increased water-sensitivity of the cured ink. In view of this, the amount of non-ionic groups is preferably at most 15 wt. % (on solids of the polyurethane A). The amount of (potentially) anionic groups present in the polyurethane A is preferably such that the acid value of the polyurethane A is in the range from 5 to 50, more preferably 10 to 50 mg KOH/g solids of the polyurethane A. As used herein, the acid value is determined by ASTM D-4662-03. Preferred anionic groups are acidic groups. Preferred non-ionic groups are polyethylene oxide groups.

The number average molecular weight Mₙ of the polyurethane A is preferably in the range from 800 to 50000 Daltons, more preferably in the range of 1000 to 25000 Daltons, most preferably in the range of 1100 to 20000 Daltons, especially preferred in the range of 1200 to 15000 Daltons.

The polydispersity index M_{w}/Mₙ of the polyurethane A is preferably in the range from 1 to 10, more preferably from 2 to 8. Molecular weights and polydispersity indices are determined as described in the experimental part herein below.

The dispersed particles present in the dispersion according to the invention preferably have an average particle size of at least 10 nm and preferably at most 200 nm, whereby the average particle size is measured as described in the experimental part herein below.

The polyurethane A present in the dispersion of the present invention comprises as building blocks at least
(a) a polyisocyanate(s),
(b) a component(s) (b) containing or providing a (meth)acrylamide functional group(s),
(c) a component(s) (c) containing an isocyanate-reactive group(s) and an anionic group(s) which is capable to render the polyurethane A dispersible in the aqueous dispersing medium either directly or after reaction with a neutralizing agent to provide a salt, whereby component (c) being different from component (b), and
(d) a component(s) (d) containing at least one isocyanate-reactive group(s), whereby component (d) being different from component (b) and (c).

A preferred isocyanate-reactive group is a hydroxyl group.

Methods for preparing polyurethanes are known in the art and are described in for example the Polyurethane Handbook 2^{nd} Edition, a Carl Hanser publication, 1994, by G. Oertel. The polyurethane A present in the radiation-curable aqueous dispersion may be prepared in a conventional manner by reacting at least (a), (b), (c) and (d) by methods well known in the prior art. Usually an isocyanate-terminated polyurethane pre-polymer (I) is first formed by the reaction of at least components (a), (b), (c) and (d) which is then preferably chain extended with an active hydrogen containing compound (II).

### Component (a)

Component (a) is preferably at least one organic difunctional isocyanate. The amount of component (a) relative to the total amount of components used to prepare the polyurethane A is usually from 5 to 55 wt. % and preferably from 10 to 45 wt. %, most preferably 15 to 40 wt. %.

Examples of suitable organic difunctional isocyanates (component (a)) include ethylene diisocyanate, 1,6-hexamethylene diisocyanate (HDI), isophorone diisocyanate (IPDI), cyclohexane-1,4-diisocyanate, dicyclohexylmethane diisocyanate such as 4,4′-dicyclohexylmethane diisocyanate (4,4′-H₁₂ MDI), p-xylylene diisocyanate, p-tetramethylxylene diisocyanate (p-TMXDI) (and its meta isomer m-TMXDI), 1,4-phenylene diisocyanate, hydrogenated 2,4-toluene diisocyanate, hydrogenated 2,6-toluene diisocyanate, 4,4′-diphenylmethane diisocyanate (4,4′-MDI), polymethylene polyphenyl polyisocyanates, 2,4′-diphenylmethane diisocyanate, 3(4)-isocyanatomethyl-1-methyl cyclohexyl isocyanate (IMCI) and 1,5-naphthylene diisocyanate. Preferred organic difunctional isocyanates are IPDI, H₁₂MDI and HDI. Mixtures of organic difunctional isocyanates can be used.

### Component (b)

Component (b) is a component(s) containing or providing a (meth)acrylamide functional group(s). Preferably, component (b) is a component(s) containing a (meth)acrylamide functional group(s) and an isocyanate-reactive group(s) (component (b1)) and/or a component(s) containing a (meth)acrylamide functional group(s) and an isocyanate group(s) (component (b2)) and/or a component(s) providing a (meth)acrylamide functional group(s) (component (b3)). More preferably, component (b) is a component(s) containing a (meth)acrylamide functional group(s) and an isocyanate-reactive group(s) (component (b1)) and/or a component(s) containing a (meth)acrylamide functional group(s) and an isocyanate group(s) (component (b2)). Component (b3) is preferably a component(s) that reacts in situ into a (meth)acrylamide functional group(s).

The amount of component (b) relative to the total amount of components used to prepare the polyurethane A is chosen such that the amount of (meth)acrylamide functional groups in the polyurethane A is as defined above. Component (b) is preferably a component containing a (meth)acrylamide functional group(s), i.e. component (b1) and/or component (b2). In a preferred embodiment, component (b) is at least one component containing an isocyanate-reactive group(s) and a (meth)acrylamide functional group(s), i.e. component (b1). In a more preferred embodiment, component (b) is at least one component containing an isocyanate group(s) and a (meth)acrylamide functional group(s), i.e. component (b2).

Component (b1) is preferably at least one compound(s) containing an isocyanate-reactive group(s) and a (meth)acrylamide functional group(s). Examples of suitable components (b1) are N-hydroxymethyl(meth)acrylamide, N-hydroxyethyl(meth)acrylamide, N-hydroxypropyl(meth)acrylamide, N,N-bis(hydroxyethyl)acrylamide, N,N-bis(hydroxypropyl)acrylamide and any mixture thereof. A preferred component (b1) is N-hydroxyethyl(meth)acrylamide. A more preferred component (b1) is N-2-hydroxyethyl(meth)acrylamide. Most preferably N-2-hydroxyethylacrylamide is used as component (b1).

Component (b2) is at least one component containing an isocyanate group(s) and a (meth)acrylamide functional group(s). Component (b2) can be prepared by reacting in the presence of a catalyst an isocyanate compound having at least two isocyanate groups with (meth)acrylic acid. Suitable isocyanate compounds are exemplified by butane diisocyanate, cyclohexane diisocyanate, dicyclohexylmethane 4,4′-diisocyanate (HMDI), hexamethylene diisocyanate (HDI), isophorone diisocyanate (IPDI), 2,2,4-trimethylhexamethylene diisocyanate, tetramethylxylene diisocyanate (TMXDI), xylene diisocyanate, methylene diphenyl diisocyanate (MDI), 1,5-naphthalene diisocyanate, toluene diisocyanate (TDI) and triisocyanurates such as HDI triisocyanurate. Such exemplary isocyanates may be used alone, or alternatively, in combinations of two or more. Suitable carboxylic acids monomers are acrylic acid and methacrylic acid. The amount of the isocyanate compound and the amount of (meth)acrylic acid preferably allows the (meth)acrylic acid to be used up. Typically, the molar ratio of the isocyanate group to the carboxylic acid group is about 1.0 to about 2.0. Suitable catalysts are exemplified by organometallic compounds, metal salts, and tertiary amines, among others. These catalysts may be used alone or in combinations of two or more. Particularly suitable catalysts are aluminium chloride, calcium chloride, magnesium chloride, and zinc acetate, among others. In a preferred embodiment of the invention, the polyurethane A comprises (meth)acrylamide functional groups introduced into the polyurethane A by using component (b2) as building block in view of food-contact approval. Component (b2) is preferably obtained in-situ before preparation of the urethane prepolymer (i.e. before adding the other urethane prepolymer components) by reacting in the presence of a catalyst an isocyanate compound having at least two isocyanate groups with (meth)acrylic acid. The in-situ preparation is advantageous in view of REACH legislation since the isocyanate compounds and (meth)acrylic acid are REACH compliant. More preferably, component (b2) is obtained in-situ just before preparation of the urethane prepolymer by reacting in the presence of a catalyst an isocyanate compound having at least two isocyanate groups with acrylic acid resulting in that polyurethane A is acryloyl amide functional. In this preferred embodiment of the invention, the anionic functionality of the polyurethane A is preferably obtained by incorporating sulfonate groups into the polyurethane A, for example by using a sulfonate based compound, such as for example Vestamin A95, as chain extender after the prepolymer preparation.

Component (b3) is preferably a compound(s) that reacts in situ into a (meth)acrylamide functional group(s). A suitable component (b3) is acrylic acid that is reacted with a NCO functional prepolymer to form the desired acrylamide functional group(s).

### Component (c)

Component (c) is at least one component containing an isocyanate-reactive group(s) and an anionic group(s) which is capable to render the polyurethane A dispersible in the aqueous dispersing medium either directly or after reaction with a neutralizing agent to provide a salt, whereby component (c) being different from component (b). The amount of isocyanate-reactive component(s) containing anionic or potentially anionic water-dispersing groups relative to the total weight amount of components used to prepare the polyurethane A is usually from 1 to 15 wt. %, preferably from 2 to 12 wt. % and even more preferably from 3 to 10 wt. %. Preferred anionic water-dispersing groups are as described above.

### Component (d)

Component (d) is at least one component containing at least one isocyanate-reactive group. Component (d) being different from component (b) and (c). The amount of component (d) relative to the total amount of components used to prepare the polyurethane is usually from 20 to 79 wt. %, preferably from 30 to 75 wt. % and even more preferably from 40 to 70 wt. %. Preferred components (d) are polyols which may be selected from any of the chemical classes of polyols that can be used in polyurethane synthesis. In particular the polyol may be a polyester polyol, a polyesteramide polyol, a polyether polyol, a polythioether polyol, a polycarbonate polyol, a polyacetal polyol, a polyvinyl polyol and/or a polysiloxane polyol. Preferred are the polyester polyols, polyether polyols and polycarbonate polyols. Preferably the number average molecular weight of component (d) is within the range of from 400 to 5000, more preferably 500 to 3000.

In case the polyurethane A present in the dispersion of the present invention also comprises non-ionic groups to provide at least a part of the hydrophilicity required to enable the polyurethane A to be stably dispersed in the aqueous dispersing medium, then the polyurethane A further comprises as component (d) a component(s) containing an isocyanate-reactive group(s) and a water-dispersing non-ionic group(s). Preferred non-ionic water-dispersing groups are polyalkylene oxide groups such as polyethylene oxide and polypropylene oxide groups. Most preferred non-ionic water-dispersing groups are polyethylene oxide groups.

In an embodiment of the present invention, the polyurethane A present in the dispersion of the present invention may further comprise as building blocks a component(s) (e) containing an isocyanate-reactive group(s) and an (meth)acryloyl ester functional group(s). Suitable components (e) are exemplified by polyester acrylates, epoxy acrylates, polyether acrylates (such as polypropyleneglycol acrylate and polyethylene glycol acrylate), hydroxyethyl(meth)acrylate, hydroxypropyl(meth)acrylate, hydroxybutyl(meth)acrylate, trimethylolpropane di(meth)acrylates and their polyethoxylated and polypropoxylated equivalents, pentaerythritol tri(meth)acrylate and their polyethoxylated and polypropoxylated equivalents, ditrimethylolpropane tri(meth)acrylate and their polyethoxylated and polypropoxylated equivalents. Such exemplary components (e) may be used alone, or alternatively, in combinations of two or more. Preferred components (e) are selected from the group consisting of hydroxyethyl(meth)acrylate, hydroxypropyl(meth)acrylate, hydroxybutyl(meth)acrylate and any mixture thereof and/or from the group consisting of trimethylolpropane di(meth)acrylates, pentaerythritol tri(meth)acrylate, ditrimethylolpropane tri(meth)acrylate and their polyethoxylated and polypropoxylated equivalents and any mixture thereof. In this embodiment, the molar amount of (meth)acryloyl amide functional groups present in the polyurethane relative to the molar amount of (meth)acryloyl ester functional groups present in the polyurethane is preferably in the range from 25:75 to 99:1

In a preferred embodiment of the present invention, the polyurethane A present in the dispersion of the present invention is free of (meth)acryloyl ester functional group(s). Accordingly, in this preferred embodiment, the polyurethane A does not comprise as building blocks a component(s) (e) containing an isocyanate-reactive group(s) and an (meth)acryloyl ester functional group(s).

Usually a polyurethane (pre-)polymer (I) is formed by the reaction of at least components (a), (b), (c) and (d). In case the NCO/OH ratio is >1, the polyurethane prepolymer (i.e. an isocyanate terminated polyurethane pre-polymer) is chain extended with an active hydrogen containing compound (II). Active hydrogen-containing chain extending compounds, which may be reacted with the isocyanate-terminated pre-polymer include water, amino-alcohols, primary or secondary diamines or polyamines (including compounds containing a primary amino group and a secondary amino group), aminosulphonates, hydrazine and substituted hydrazines. Examples of such chain extending compounds useful herein include 2-(methylamino)ethylamine, aminoethyl ethanolamine, aminoethylpiperazine, diethylene triamine, and alkylene diamines such as ethylene diamine, and cyclic amines such as isophorone diamine. Also compounds such as hydrazine, azines such as acetone azine, substituted hydrazines such as, for example, dimethyl hydrazine, 1,6-hexamethylene-bis-hydrazine, carbodihydrazine, hydrazides of dicarboxylic acids, adipic acid dihydrazide, oxalic acid dihydrazide, isophthalic acid dihydrazide, and sulphonic acids such as amino sulphonates. Hydrazides made by reacting lactones with hydrazine, bis-semi-carbazide, and bis-hydrazide carbonic esters of glycols may be useful. Preferred chain extending compounds are selected from the group consisting of water and/or aminosulphonates. Preferably the molar ratio between the active hydrogen present in the active-hydrogen chain extending compound other than water to isocyanate (NCO) groups present in the isocyanate-terminated polyurethane pre-polymer is in the range of from 0.5:1 to 1.2:1, more preferably 0.6:1 to 1.1:1, especially 0.75:1 to 1.02:1 and most preferably 0.78:1 to 0.98:1.

The radiation-curable aqueous dispersion according to the present invention optionally contains radiation-curable diluent, i.e. multifunctional ethylenically unsaturated components which under the influence of irradiation (optionally in combination with the presence of a (photo)initiator) can undergo crosslinking by free radical polymerisation, but being unreactive towards isocyanate groups (i.e. containing no functionality which is capable to react with an isocyanate group) under the conditions of the polyurethane preparation reaction, and which are able to reduce the viscosity of the composition, for example by adding radiation-curable diluent during the synthesis of the polyurethane A and/or by adding radiation-curable diluent to the dispersion. Preferably the dispersion contains less than 40 wt. % of radiation-curable diluent, preferably less than 30 wt. % of radiation-curable diluent, more preferably less than 20 wt. % of radiation-curable diluent, more preferably less than 10 wt. % of radiation-curable diluent, more preferably less than 5 wt. % of radiation-curable diluent, more preferably less than 3 wt. % of radiation-curable diluent, more preferably less than 1 wt. % of radiation-curable diluent (relative to the total weight of the dispersion of the present invention). Preferred radiation-curable diluents are non-skin irritant and highly functional acrylated polyols like (meth)acrylated epoxidized oils and dipentaerythritolhexaacrylate. Preferably, the amount of (meth)acryloyl ester functional group(s) present in the dispersion is at most 4 meq/g solids content of the dispersion.

The radiation-curable aqueous dispersion according to the present invention preferably comprises polyurethane A in an amount of from 10 to 50% by solids weight, based on the total solids weight of the dispersion.

The present invention further relates to an ink or a coating composition comprising the dispersion as described above. The ink or coating composition preferably further comprises a photo-initiator.

The present invention further relates to a method for coating a substrate selected from the group consisting of wood, metal, plastic, linoleum, concrete, glass, packaging films and any combination thereof; where the method comprises

(i) applying an aqueous coating composition according to the invention or obtained with the process according to the invention to the substrate; and
(ii) physically drying (by evaporation of volatiles) and curing by radiation (preferably UV radiation) of the aqueous coating composition to obtain a coating.

The present invention further relates to a substrate having a coating obtained by (i) applying an aqueous coating composition according to the invention or obtained with the process according to the invention to a substrate and (ii) physically drying and curing by radiation (preferably UV-radiation) of the aqueous coating composition to obtain a coating. The substrate is preferably selected from the group consisting of wood, metal, plastic, linoleum, concrete, glass and any combination thereof. More preferably, the substrate is selected from the group consisting of wood, PVC, linoleum and any combination thereof.

The ink composition according to the invention can suitably be used in digital printing ink formulations, more preferred ink-jet printing formulations. Digital printing is a method of printing from a digital-based image directly to a variety of media. For ink applications, the dispersion is mixed with a pigment (possibly a self-dispersible pigment or a pigment in combination with a suitable dispersant) in an aqueous media (optionally including water soluble organics like glycols, glycol ethers, glycerin) to form an ink. The ink will be called a formulation and can include other additives such as humectants, other binders, viscosity modifiers, surface active agents, corrosion inhibitors, etc. The amount of polyurethane A in the ink composition is usually in the range from 1 to 25 wt. %, preferably in the range from 2 to 20 wt. %, relative to the total weight of the ink composition.

The present invention is now illustrated by reference to the following examples. Unless otherwise specified, all parts, percentages and ratios are on a weight basis.

Components and abbreviations used:
IPDI=Desmodur I, Isophorone diisocyanate, from Covestro
N3300=Desmodur N3300, HDI isocyanurate trimer from Covestro
Ymer N120=Polymeric non-ionic dispersing compound, OH-number=120 mg KOH/g from Perstorp polyols
H12MDI=Desmodur W, 4,4-dicyclohexyl methane diisocyanate, from Covestro
HDI=Desmodur H, hexamethylene diisocyanate, from Covestro
TMDI=Vestanat TMDI, 2,2,4- and 2,4,4-trimethyl-hexamethylene diisocyanate, from Evonik
DMPA=Dimethylolpropionic acid available from Perstorp polyols
pTHF650=Polytetramethylene ether glycol, OH-number=172 mg KOH/g available from BASF
pTHF1000=Polytetramethylene ether glycol, OH-number=112 mg KOH/g available from BASF
PEG1000=polyethyleneglycol, OH-number=112 mg KOH/g from Alfa Aesar
HEAAm=N-Hydroxyethylacrylamide available from KJ Chemicals Corporation
HEA=2-Hydroxyethylacrylate available from ECEM
DPHA=Agisyn 2830, dipentaerythritol hexaacrylate, from AGI-DSM
BHT=Butylated hydroxyl toluene available from Merisol
MgCl₂=Magnesium chloride available from Aldrich
KOH 15%=Potassium hydroxide, 15% solution in water from Brenntag
Vestamin A95=Sodium salt of an amino functional sulfonic acid from Evonik
Acetone=solvent available from Brenntag
BYK011=defoamer from Byk
Omnirad 1173=photoinitiator from IGM
Omnirad TPO-L=photoinitiator from IGM
Surfynol 420=non-ionic surfactant from Evonik
Bismuthneodecanoate=Catalyst from TIB chemicals AG
PC diol=Durez-ter S2001-120, OH-number=120 mg KOH/g, from Durez
NBP=n-butyl pyrrolidone from Eastman
DBTDL=dibutyltin dilaurate from Reaxis
TEA=tri-ethylamine from Arkema
EDA=ethylenediamine from BASF
TMPTA=trimethylolpropane triacrylate, Agisyn 2811, from DSM
DiTMPTA=ditrimethylolpropane tetraacrylate, Agisyn 2887, from DSM
TPGDA=tripropyleneglycol diacrylate, Agisyn 2863, from DSM

### Solid Content

The solid content of the dispersion was measured on a HB43-S halogen moisture analyzer from Mettler Toledo at a temperature of 130° C.

### Viscosity

The viscosity of the binder after preparation was determined using a Brookfield LV (spindle 61, 60 rpm, RT)

The viscosity stability of all binders diluted to 30% solids was determined in time using a Brookfield LV with ULA adapter (60 rpm, 25° C.).

### Average Particle Size PS:

The intensity average particle size, z-average, has been determined by photon correlation spectroscopy using a Malvern Zetasizer Nano ZS. Samples are diluted in demineralized water to a concentration of approximately 0.1 g dispersion/liter. Measurement temperature 25° C. Angle of laser light incidence 173°. Laser wavelength 633 nm.

### Size Exclusion Chromatography in HFIP

The number average molecular weight, weight average molecular weight and molecular weight distribution is measured with three silica modified 7 μm PFG columns at 40° C. on a Waters Alliance 2695 LC system with a Waters 2410 DRI detector and a Waters 2996 PDA detector. Hexafluoroisopropanol (HFIP) and PTFA 0.1% is used as eluent with a flow of 0.8 mL/min. The samples are dissolved in the eluent using a concentration of 5 mg polymer per mL solvent. The solubility is judged with a laser pen after 24 hours stabilization at room temperature; if any scattering is visible the samples are filtered first and 150 μl sample solution is injected. The MW (molecular weights) and MWD (molecular weight distribution) results are calculated with 11 narrow poly methylmethacrylate standards from 645-1.677.000 Da.

### Resolubility

The resolubility before UV cure was tested by dipping the coated but uncured substrate into a water bath for 60 seconds. If the ink completely dissolves in water without leaving ink residues on the substrate the resolubility scores+, if a portion of the ink was not dissolved the resolubility scores+/− and if the ink complete remains on the substrate the resolubility scores −.

### Water and Ethanol Resistance

A wad of absorbent cotton is soaked into the chemical and rubbed with strong movements over the cured formulation, from the left to the right and from the right to the left, until the amount of rubs is reached. The resistance against water and ethanol (attack, dissolving, deterioration or hazing) is visually evaluated.

### Judgement Scale:

5 Very good; no attack or deterioration observed
4 Only very minor damage or hazing or dissolving
3 Clear hazing, deterioration or dissolving
2 Coating layer dissolved at some spots
1 Very bad: layer of coating entirely or practically entirely dissolved

### EXAMPLES AND COMPARATIVE EXPERIMENTS

The following examples were prepared and tested. The compositions of the examples and results are as shown in the tables below.

### Preparation of Radiation Curable Polyurethane Dispersion

### Example 1

A 1000 cm³ flask equipped with a thermometer and overhead stirrer was charged with components DMPA (14.4 g), pTHF650 (148.6 g), HEAAm (29.2 g), IPDI (107.9 g), acetone (75.0 g) and BHT (0.45 g). The reaction was heated to 50° C. and 0.06 g of Bismuthneodecanoate was added. The reaction was kept at 60° C. until the NCO content of the resultant urethane prepolymer was 0.65% on solids (theoretically 0.47%). The prepolymer was cooled down to 50° C. and a 15% KOH solution was added (40.0 g). A dispersion of the resultant prepolymer was made by adding deionized water (549.6 g) to the prepolymer mixture. Subsequently BYK011 was added (0.09 g) and the acetone was removed from the dispersion by distillation under vacuum. The dispersion was diluted with water until a solid content of 30 wt % was reached. The specifications of the resultant polyurethane dispersion are given in Table 1 and 2.

### Example 2

A 1000 cm³ flask equipped with a thermometer and overhead stirrer was charged with IPDI (123 g), BHT (0.31 g) and MgCl₂ (0.66 g). The mixture was heated to 70° C. and then acrylic acid (22.5 g) was slowly fed to the reactor in 30 minutes. After the feed was completed the reaction was kept at 85° C. for 60 minutes. The mixture was cooled to 35° C. and pTHF650 (146.0 g), Ymer N120 (14.6 g) and BHT (0.16 g) were charged to the reactor. Upon heating to 50° C. bismuth neodecanoate (0.21 g) was added. The mixture was allowed to exotherm and kept at 90° C. for 3 hours. The conversion was monitored by FT-IR. After the reaction was completed the mixture was cooled to 60° C. and dissolved in acetone (101.3 g). Vestamin A95 (27.1) was added and mixed for 15 minutes. Subsequently the reaction mixture was dispersed by adding water (482.8 g). The acetone was stripped off by vacuum distillation. Before distillation BYK011 (0.04 g) was added to prevent severe foaming. The specifications of the resultant polyurethane dispersion after filtration are given in Table 1 and 2.

### Example 3

A 1000 cm³ flask equipped with a thermometer and overhead stirrer was charged with N3300 (23.5 g), IPDI (94.1 g), BHT (0.31 g) and MgCl₂ (0.66 g). The mixture was heated to 70° C. and then acrylic acid (22.5 g) was slowly fed to the reactor in 30 minutes. After the feed was completed the reaction was kept at 85° C. for 60 minutes. The mixture was cooled to 35° C. and pTHF1000 (151.5 g), Ymer N120 (14.6 g) and BHT (0.16 g) were charged to the reactor. Upon heating to 50° C. bismuth neodecanoate (0.21 g) was added. The mixture was allowed to exotherm and kept at 90° C. for 3 hours. The conversion was monitored by FT-IR. After the reaction was completed the mixture was cooled to 60° C. and dissolved in acetone (101.3 g). Vestamin A95 (27.1) was added and mixed for 15 minutes. Subsequently the reaction mixture was dispersed by adding water (482.8 g). The acetone was stripped off by vacuum distillation. Before distillation BYK011 (0.04 g) was added to prevent severe foaming. The specifications of the resultant polyurethane dispersion after filtration are given in Table 1 and 2.

### Example 4

A 1000 cm³ flask equipped with a thermometer and overhead stirrer was charged with H12MDI (130.8 g), BHT (0.31 g) and MgCl₂ (0.66 g). The mixture was heated to 70° C. and then acrylic acid (22.5 g) was slowly fed to the reactor in 30 minutes. After the feed was completed the reaction was kept at 85° C. for 60 minutes. The mixture was cooled to 35° C. and pTHF650 (138.4 g), Ymer N120 (14.6 g) and BHT (0.16 g) were charged to the reactor. Upon heating to 50° C. bismuth neodecanoate (0.21 g) was added. The mixture was allowed to exotherm and kept at 90° C. for 3 hours. The conversion was monitored by FT-IR. After the reaction was completed the mixture was cooled to 60° C. and dissolved in acetone (101.3 g). Vestamin A95 (27.1 g) was added and mixed for 15 minutes. Subsequently the reaction mixture was dispersed by adding water (482.8 g). The acetone was stripped off by vacuum distillation. Before distillation BYK011 (0.04 g) was added to prevent severe foaming. The specifications of the resultant polyurethane dispersion after filtration are given in Table 1 and 2.

### Example 5

A 1000 cm³ flask equipped with a thermometer and overhead stirrer was charged with components DMPA (10.1 g), pTHF650 (105.0 g), HEAAm (20.6 g), IPDI (76.3 g), acetone (53.0) and BHT (0.32 g). The reaction was heated to 50° C. and 0.04 g of Bismuthneodecanoate was added. The reaction was kept at 60° C. until the NCO content of the resultant urethane prepolymer was 0.37% on solids (theoretically 0.52%). The prepolymer was cooled down to 40° C. and DiTMPTA (8.4 g) was added. After mixing for 5 minutes, a 15% KOH solution was added (28.3 g). A dispersion of the resultant prepolymer was made by adding deionized water (518.6 g) to the prepolymer mixture. Subsequently BYK011 was added (0.06 g) and the acetone was removed from the dispersion by vacuum distillation. The dispersion was diluted with water until a solid content of 30 wt % was reached. The specifications of the resultant polyurethane dispersion after filtration are given in Table 1 and 2.

### Example 6

To 300 gram of example 2, 14.0 g of HEAAm and 152.6 g of water was added at room temperature and mixed for 15 minutes. The specifications of the resultant polyurethane after filtration dispersion are given in Table 1 and 2.

### Example 7

A 1000 cm³ flask equipped with a thermometer and overhead stirrer was charged with IPDI (116.4 g), BHT (0.31 g) and MgCl₂ (0.66 g). The mixture was heated to 70° C. and then acrylic acid (22.5 g) was slowly fed to the reactor in 30 minutes. After the feed was completed the reaction was kept at 85° C. for 60 minutes. The mixture was cooled to 35° C. and pTHF650 (123.5 g), Ymer N120 (14.6 g), DPHA (29.3) and BHT (0.16 g) were charged to the reactor. Upon heating to 50° C. bismuth neodecanoate (0.21 g) was added. The mixture was allowed to exotherm and kept at 90° C. for 3 hours. The conversion was monitored by FT-IR. After the reaction was completed the mixture was cooled to 60° C. and dissolved in acetone (101.3 g). Vestamin A95 (27.1) was added and mixed for 15 minutes. Subsequently the reaction mixture was dispersed by adding water (482.8 g). The acetone was stripped off by vacuum distillation. Before distillation BYK011 (0.04 g) was added to prevent severe foaming. The specifications of the resultant polyurethane dispersion after filtration are given in Table 1 and 2.

### Example 8

A 1000 cm³ flask equipped with a thermometer and overhead stirrer was charged with Desmodur H (19.7 g), IPDI (78.6 g), BHT (0.31 g) and MgCl₂ (0.65 g). The mixture was heated to 70° C. and then acrylic acid (22.3 g) was slowly fed to the reactor in 30 minutes. After the feed was completed the reaction was kept at 85° C. for 60 minutes. The mixture was cooled to 35° C. and pTHF1000 (167.6 g), Ymer N120 (14.5 g) and BHT (0.16 g) were charged to the reactor. Upon heating to 50° C. bismuth neodecanoate (0.20 g) was added. The mixture was allowed to exotherm and kept at 90° C. for 3 hours. The conversion was monitored by FT-IR. After the reaction was completed the mixture was cooled to 60° C. and dissolved in acetone (100.1 g). Vestamin A95 (33.8) was added and mixed for 15 minutes. Subsequently the reaction mixture was dispersed by adding water (479.2 g). The acetone was stripped off by vacuum distillation. Before distillation BYK011 (0.04 g) was added to prevent severe foaming. The specifications of the resultant polyurethane dispersion after filtration are given in Table 1 and 2.

### Example 9

A 1000 cm³ flask equipped with a thermometer and overhead stirrer was charged with TMDI (118.5 g), BHT (0.31 g) and MgCl₂ (0.66 g). The mixture was heated to 70° C. and then acrylic acid (22.5 g) was slowly fed to the reactor in 30 minutes. After the feed was completed the reaction was kept at 85° C. for 60 minutes. The mixture was cooled to 35° C. and pTHF650 (150.6 g), Ymer N120 (14.6 g) and BHT (0.16 g) were charged to the reactor. Upon heating to 50° C. bismuth neodecanoate (0.21 g) was added. The mixture was allowed to exotherm and kept at 90° C. for 3 hours. The conversion was monitored by FT-IR. After the reaction was completed the mixture was cooled to 60° C. and dissolved in acetone (101.3 g). Vestamin A95 (27.1) was added and mixed for 15 minutes. Subsequently the reaction mixture was dispersed by adding water (482.8 g). The acetone was stripped off by vacuum distillation. Before distillation BYK011 (0.04 g) was added to prevent severe foaming. The specifications of the resultant polyurethane dispersion after filtration are given in Table 1 and 2.

### Comparative Experiment 1

A 1000 cm³ flask equipped with a thermometer and overhead stirrer was charged with components DMPA (14.4 g), pTHF650 (148.6 g), HEA (29.2 g), IPDI (107.9 g), acetone (75.0 g) and BHT (0.45 g). The reaction was heated to 50° C. and 0.06 g of bismuthneodecanoate was added. The reaction was kept at 60° C. until the NCO content of the resultant urethane prepolymer was 0.67% on solids (theoretically 0.47%). The prepolymer was cooled down to 50° C. and a 15% KOH solution was added (40.0 g). A dispersion of the resultant prepolymer was made by adding deionized water (549.7 g) to the prepolymer mixture. Subsequently BYK011 was added (0.09 g) and the acetone was removed from the dispersion by distillation under vacuum. The dispersion was diluted with water until a solid content of 30 wt % was reached. The specifications of the resultant polyurethane dispersion after filtration are given in Table 1 and 2. In this Comparative Experiment 1 the polyurethane has acryloyl ester functional groups, but no (meth)acryloyl amide functional groups.

### Comparative Experiment 2

A 1000 cm³ flask equipped with a thermometer and overhead stirrer was charged with components PEG1000 (193.0 g), HEAAm (30.7 g), IPDI (76.3 g) and BHT (0.45 g). The reaction was heated to 50° C. and 0.06 g of Bismuthneodecanoate was added. The reaction was kept at 80° C. until the NCO content of the resultant urethane prepolymer was 0.49% on solids (theoretically 0.46%). The prepolymer was cooled down to 65° C. and a solution of the resultant prepolymer was made by adding deionized water (468.0 g) to the prepolymer mixture. The specifications of the resultant polyurethane dispersion after filtration are given in Table 1 and 2. In this Comparative Experiment 2 the polyurethane is solely non-ionically stabilized.

### Comparative Experiment 3

A 1000 cm³ flask equipped with a thermometer and overhead stirrer was charged with components DMPA (30.4 g), PC diol (170.4 g), IPDI (161.4 g) and NBP (154.9 g). The reaction was heated to 50° C. and 0.26 g of DBTDL was added. The mixture was allowed to exotherm and kept at 90° C. for 2 hours. The NCO content of the resultant urethane prepolymer was 4.58% on solids (theoretically 5.10%). The prepolymer was cooled down to 75° C. and ethanol was added (86.7 g). After mixing at 75° C. for 2.5 hours, TEA (22.9 g) was added. A dispersion of the resultant prepolymer was made by feeding 459.7 g of this prepolymer to deionized water (496.8 g). To 300 gram of this dispersion, 45.0 g of HEAAm and 105.0 g of water was added at room temperature and mixed for 15 minutes. The specifications of the resultant polyurethane dispersion after filtration are given in Table 1 and 2. In this Comparative Experiment 3 the polyurethane does not have ethylenically unsaturated bond functionality and hence the polyurethane is not radiation-curable. The dispersion is radiation-curable due to the presence of HEAAm in the dispersion. The urethane prepolymer is capped with ethanol and dispersed in water and then HEAAm is added. There is no reaction between the polyurethane and HEAAm and consequently the amount of acrylamide functional groups in the polyurethane is 0.

### Comparative Experiment 4

A 1000 cm³ flask equipped with a thermometer and overhead stirrer was charged with components DMPA (31.3 g), PC diol (175.7 g), IPDI (166.5 g) and NBP (159.7 g). The reaction was heated to 50° C. and 0.27 g of DBTDL was added. The mixture was allowed to exotherm and kept at 90° C. for 2 hours. The NCO content of the resultant urethane prepolymer was 4.50% on solids (theoretically 5.10%). The prepolymer was cooled down to 80° C. and TEA (23.7 g) was added. A dispersion of the resultant prepolymer was made by feeding 408.6 g of this prepolymer to deionized water (476.8 g). After dispersion was done, a mixture of EDA (12.9 g) and deionized water (38.6 g) was added to the dispersion in 10 minutes and rinsed with 19.7 g deionized water. To 300 gram of this dispersion, 45.0 g of HEAAm and 105.0 g of water was added at room temperature and mixed for 15 minutes. The specifications of the resultant polyurethane dispersion after filtration are given in Table 1 and 2. In this Comparative Experiment 4 the polyurethane does not have ethylenically unsaturated bond functionality and hence the polyurethane is not radiation-curable. The dispersion is radiation-curable due to the presence of HEAAm in the dispersion. The urethane prepolymer is first dispersed in water and then chain-extended with ethylenediamine. To the chain-extended polyurethane dispersion HEAAm was added. There is no reaction between the polyurethane and HEAAm and consequently the amount of acrylamide functional groups in the polyurethane is 0.

### Comparative Experiment 5

A 1000 cm³ flask equipped with a thermometer and overhead stirrer was charged with components DMPA (20.8 g), PC diol (116.9 g), IPDI (110.7 g) and NBP (106.2 g). The reaction was heated to 50° C. and 0.18 g of DBTDL was added. The mixture was allowed to exotherm and kept at 90° C. for 2 hours. The NCO content of the resultant urethane prepolymer was 4.27% on solids (theoretically 5.10%). The prepolymer was cooled down to 80° C. and TMPTA (47.0 g), TPGDA (58.0 g), BHT (0.17 g) and TEA (23.7 g) were added. A dispersion of the resultant prepolymer was made by feeding 373.8 g of this prepolymer to deionized water (526.7 g). After dispersion was done, a mixture of EDA (9.2 g) and deionized water (27.5 g) was added to the dispersion in 10 minutes and rinsed with 19.3 g deionized water. To 300 gram of this dispersion, 45.0 g of HEAAm and 105.0 g of water was added at room temperature and mixed for 15 minutes. The specifications of the resultant polyurethane dispersion after filtration are given in Table 1 and 2. In this Comparative Experiment 5 the polyurethane does not have ethylenically unsaturated bond functionality and hence is not radiation-curable. The urethane prepolymer is prepared in the presence of TMPTA and TPGDA which are radiation-curable diluents but they are not chemically incorporated into the polyurethane since they are not isocyanate-reactive. The urethane prepolymer is first dispersed in water and then chain-extended with ethylenediamine. To the chain-extended polyurethane dispersion HEAAm was added. There is no reaction between the polyurethane and HEAAm and consequently the amount of acrylamide functional groups in the polyurethane is 0.

TABLE 1
Specifications of prepared (comparative) examples.

| | Solids | pH | PS | Viscosity | Mₙ | M_{w} |
|---|---|---|---|---|---|---|
| Sample | [%] | [−] | [nm] | [mPa · s] | [g/mol] | [g/mol] |
| Ex 1. | 30.6 | 8.1 | 37 | 11 | 1715 | 6625 |
| Ex 2. | 42.0 | 6.6 | 101 | 112 | 2352 | 33140 |
| Ex 3. | 40.6 | 6.3 | 104 | 42 | 3268 | 170909 |
| Ex 4. | 36.5 | 7.1 | 106 | 119 | 2607 | 18999 |
| Ex 5. | 31.3 | 7.9 | 40 | 17 | 1985 | 6843 |
| | | | | | 4244* | 7956* |
| Ex 6. | 30.0 | 6.7 | 89 | 6 | 2352* | 33140* |
| Ex. 7 | 39.1 | 6.3 | 63 | 34 | 1711 | 13157 |
| Ex. 8 | 39.6 | 7.3 | 71 | 31 | 2054 | 15704 |
| Ex. 9 | 38.7 | 7.4 | 64 | 105 | 2668 | 61321 |
| CEx 1. | 30.3 | 8.0 | 75 | 13 | 2209 | 6364 |
| CEx 2. | 38.0 | 7.0 | n.a. | 68 | 4565 | 25049 |
| CEx 3. | 30.1 | 8.2 | 57 | 47 | 612 | 2255 |
| | | | | | 2653* | 4005* |
| CEx 4. | 26.0 | 8.6 | 52 | 80 | 1032 | 42834 |
| | | | | | 14246* | 60099* |
| CEx 5. | 30.0 | 7.8 | 44 | 74 | 906 | 53759 |
| | | | | | 16462* | 89057* |

*Excluding fraction with molar mass < 1000 g/mol (reactive diluent)

TABLE 2
PS and viscosity of PU binders (all diluted to 30 wt % solid
content) of freshly prepared samples and upon storage at
room temperature (22 ± 2° C.) and 60° C.

| | | | Start | | | | | |
|---|---|---|---|---|---|---|---|---|
| | | | (after 1 | | | | | |
| | | | day | | | | | |
| | | Storage | storage | 3 | 7 | 14 | 21 | 28 |
| | | temp | at RT) | days | days | days | days | days |
| Ex. 1 | PS | RT | 37 | 42 | 47 | 46 | 45 | 44 |
| | (nm) | 60° C. | | 42 | 45 | 46 | 42 | 35 |
| | Viscosity | RT | 11.4 | 10.6 | 10.5 | 10.7 | 10.7 | 11.0 |
| | (mPa · s) | 60° C. | | 10.3 | 10.1 | 10.7 | 11.0 | 13.0 |
| CEx. 1 | PS | RT | 75 | 48 | 57 | 60 | 61 | 62 |
| | (nm) | 60° C. | | 82 | 102 | 106 | 107 | 106 |
| | Viscosity | RT | 12.6 | 8.6 | 8.1 | 7.9 | 7.8 | 7.8 |
| | (mPa · s) | 60° C. | | 6.5 | 5.3 | 5.6 | 5.8 | 6.1 |
| CEx. 2 | PS | RT | n.a. | | | | | |
| | (nm) | 60° C. | | | | | | |
| | Viscosity | RT | n.d. | | | | | |
| | (mPa · s) | 60° C. | | | | | | |
| Ex. 2 | PS | RT | 95 | 99 | 96 | 97 | 93 | 90 |
| | (nm) | 60° C. | | 91 | 95 | 94 | 95 | 96 |
| | Viscosity | RT | 7.6 | 7.4 | 7.3 | 7.1 | 7.1 | 7.0 |
| | (mPa · s) | 60° C. | | 7.8 | 7.8 | 7.5 | 7.1 | 6.9 |
| Ex. 3 | PS | RT | 106 | 106 | 102 | 103 | 105 | 101 |
| | (nm) | 60° C. | | 104 | 102 | 102 | 104 | 103 |
| | Viscosity | RT | 6.9 | 6.3 | 6.0 | 6.0 | 5.9 | 5.9 |
| | (mPa · s) | 60° C. | | 6.5 | 6.3 | 6.4 | 6.4 | 6.2 |
| Ex. 4 | PS | RT | 105 | 109 | 101 | 103 | 105 | 104 |
| | (nm) | 60° C. | | 112 | 101 | 103 | 103 | 99 |
| | Viscosity | RT | 16.3 | 15.6 | 14.9 | 14.4 | 14.5 | 14.8 |
| | (mPa · s) | 60° C. | | 13.3 | 12.7 | 12.6 | 13.3 | 13.0 |
| Ex. 5 | PS | RT | 40 | 44 | 44 | 44 | 47 | 46 |
| | (nm) | 60° C. | | 45 | 43 | 42 | 42 | 41 |
| | Viscosity | RT | 11.5 | 10.4 | 10.5 | 10.3 | 10.4 | 10.6 |
| | (mPa · s) | 60° C. | | 10.1 | 10.5 | 10.7 | 10.9 | 10.9 |
| Ex. 6 | PS | RT | 89 | | 89 | 89 | 92 | 92 |
| | (nm) | 60° C. | | | 87 | 88 | 88 | 92 |
| | Viscosity | RT | 6.2 | 5.8 | 5.8 | 5.7 | 5.8 | 5.6 |
| | (mPa · s) | 60° C. | | 6.0 | 6.0 | 5.8 | 5.7 | 5.6 |
| Ex. 7 | PS | RT | 65 | | 65 | 64 | 65 | 65 |
| | (nm) | 60° C. | | | 73 | 77 | 78 | 79 |
| | Viscosity | RT | 6.6 | | 6.9 | 6.9 | 6.8 | 6.8 |
| | (mPa · s) | 60° C. | | | 6.5 | 6.6 | 6.3 | 6.1 |
| Ex. 8 | PS | RT | 71 | | 73 | 66 | 71 | 72 |
| | (nm) | 60° C. | | | 72 | 68 | 68 | 73 |
| | Viscosity | RT | 6.3 | | 6.7 | 6.7 | 6.5 | 6.5 |
| | (mPa · s) | 60° C. | | | 6.6 | 6.5 | 6.4 | 6.3 |
| Ex. 9 | PS | RT | 64 | | 70 | 68 | 69 | 69 |
| | (nm) | 60° C. | | | 73 | 69 | 68 | 74 |
| | Viscosity | RT | 11.8 | | 11.9 | 11.7 | 11.2 | 11.2 |
| | (mPa · s) | 60° C. | | | 11.8 | 11.8 | 11.6 | 11.4 |
| CEx. | PS | RT | 55 | 58 | 60 | 64 | 61 | 57 |
| 3 | (nm) | 60° C. | | 99 | 146 | 165 | 192 | 189 |
| | Viscosity | RT | 8.2 | 8.0 | 8.0 | 7.9 | 7.8 | 7.8 |
| | (mPa · s) | 60° C. | | 7.8 | 7.7 | 7.7 | 7.7 | 7.6 |
| CEx. | PS | RT | 51 | 55 | 50 | 50 | 55 | 57 |
| 4 | (nm) | 60° C. | | 41 | 38 | 40 | 38 | 35 |
| | Viscosity | RT | 21.0 | 19.1 | 18.4 | 16.7 | 16.1 | 15.5 |
| | (mPa · s) | 60° C. | | 11.9 | 12.7 | 12.2 | 12.2 | 12.5 |
| CEx. | PS | RT | 41 | 45 | 39 | 39 | 45 | 43 |
| 5 | (nm) | 60° C. | | 54 | 44 | 50 | 55 | 77 |
| | Viscosity | RT | 10.7 | 9.6 | 9.3 | 9.1 | 9.0 | 8.9 |
| | (mPa · s) | 60° C. | | 8.2 | 7.1 | 6.1 | 5.7 | 5.3 |

It can be seen from Table 2 that the examples according to the invention retain their particle size and viscosity stability even after prolonged storage at elevated temperatures, whereas the particle size of the dispersions according to the comparative examples CEx1, CEx3 & CEx5 show a significant increase upon storage and/or a pronounced viscosity drop.

The binders of the Examples and Comparative Experiments were formulated according to Table 3.

TABLE 3
Formulation
Formulation

| | |
|---|---|
| Resin [20 wt % solid content] | 42.5 |
| ProJet ™ Cyan APD1000 | 7.5 |
| supplied by FujiFilm | |
| Surfynol 420 | 0.3 |
| Omnirad TPO-L | 0.3 |
| Omnirad 1173 | 0.3 |

Application conditions

| | |
|---|---|
| Wet Film Thickness | 12 μm |
| Substrate | White PE foil |
| Drying conditions | 180 seconds @ 90° C. |
| Cure conditions | 2 pass @ 500 mJ, Mercury lamp |

TABLE 4
Application properties

| | | | | | 25% EtOH |
|---|---|---|---|---|---|
| | | | | Water | resistance |
| | | | | resistance of | of cured |
| | | Tackiness | Tackiness | cured film | film [tissue |
| | | before | after | [tissue hand | hand 100 |
| | Resolubility | cure | cure | 100 rubs] | rubs] |
| Ex. 1 | + | Tacky | Tack-free | 4 | 4 |
| CEx. 1 | + | Tacky | Tack-free | 3 | 3 |
| CEx. 2 | + | Tacky | Tacky | 1 | 1 |
| Ex 2. | + | Tacky | Tack-free | 5 | 4 |
| Ex 3. | − | Tacky | Tack-free | 5 | 4 |
| Ex 4. | +/− | Tacky | Tack-free | 5 | 4 |
| Ex 5. | + | Tacky | Tack-free | 5 | 4 |
| Ex 6. | + | Tacky | Tack-free | 5 | 4 |
| Ex. 7 | + | Tacky | Tack-free | 5 | 5 |
| Ex. 8 | +/− | Tacky | Tack-free | 2 | 2 |
| Ex. 9 | + | Tacky | Tack-free | 3 | 3 |
| CEx. 3 | − | Tacky | Slightly | 0 | 0 |
| | | | Tacky | | |
| CEx. 4 | − | Tack-free | Tack-free | 5 | 5 |
| CEx. 5 | − | Tack-free | Tack-free | 5 | 5 |

1. A radiation-curable aqueous polyurethane dispersion, wherein the dispersion comprises anionically stabilized polyurethane A present in disperse form, and wherein said polyurethane A comprises (meth)acrylamide functional groups in an amount of at least 0.2 mmol per g of the polyurethane A.

2. The dispersion according to claim 1, wherein the polyurethane A comprises (meth)acrylamide functional groups in an amount of at least 0.35 mmol per g of the polyurethane A, more preferably in an amount of at least 0.5 mmol per g of the polyurethane A.

3. The dispersion according to claim 1, wherein the polyurethane A comprises (meth)acrylamide functional groups in an amount of at most 6 mmol per g of the polyurethane A, more preferably in an amount of at most 4 mmol per g of the polyurethane A and most preferably in an amount of at most 2.5 mmol per g of the polyurethane A.

4. The dispersion according to claim 1, wherein the amount of (meth)acrylamide functional groups present in the polyurethane A is chosen such to result in at least 50 mol % of the ethylenically unsaturated bond concentration of the polyurethane A, more preferably at least 75 mol %, even more preferably at least 90 mol % and most preferably 100 mol % of the ethylenically unsaturated bond concentration of the polyurethane A.

5. The dispersion according to claim 1, wherein said polyurethane A comprises acrylamide functional groups.

6. The dispersion according to claim 1, wherein the amount of (meth)acryloyl ester functional group(s) present in the dispersion is at most 4 meq/g solids content of the dispersion.

7. The dispersion according to claim 1, wherein the at least for a part anionically stabilized polyurethane A contains anionic functional groups selected from the group consisting of carboxylate groups, sulfonate groups, phosphonate groups and any combination thereof.

8. The dispersion according to claim 1, wherein the polyurethane A contains carboxylic acid groups and/or sulfonic acid groups which become anionic when deprotonated.

9. The dispersion according to claim 1, wherein a hydroxy-carboxylic acid(s), preferably a dihydroxy alkanoic acid(s), more preferably α,α-dimethylolpropionic acid, is chemically incorporated into the polyurethane A to provide after deprotonation at least a part of the hydrophilicity required to enable the polyurethane A to be stably dispersed in the aqueous dispersing medium.

10. The dispersion according to claim 8, wherein the neutralizing agent used to deprotonate (neutralize) the carboxylic acid groups and/or sulfonic acid groups is an alkali metal hydroxide.

11. The dispersion according to claim 1, wherein the polyurethane A is also non-ionically stabilized by chemically incorporating polyethylene oxide and/or polypropylene oxide units into the polyurethane A.

12. The dispersion according to claim 11, wherein the amount of (potentially) anionic functional groups present in the polyurethane A is such that the acid value of the polyurethane A is in the range from 10 to 50 mg KOH/g solids of the polyurethane A.

13. The dispersion according to claim 1, wherein the number average molecular weight Mₙ of the polyurethane A is in the range from 800 to 50000 Daltons, more preferably in the range of 1000 to 25000 Daltons, most preferably in the range of 1100 to 20000 Daltons, especially preferred in the range of 1200 to 15000 Daltons.

14. The dispersion according to claim 1, wherein the polyurethane A comprises as building blocks at least
(a) a polyisocyanate(s),
(b) a component(s) containing or providing a (meth)acrylamide functional group(s),
(c) a component(s) containing an isocyanate-reactive group(s) and an anionic group(s) which is capable to render the polyurethane A dispersible in the aqueous dispersing medium either directly or after reaction with a neutralizing agent to provide a salt, whereby component (c) being different from component (b), and
(d) a component(s) containing at least one isocyanate-reactive group(s), whereby component (d) being different from component (b) and (c).

15. The dispersion according to claim 14, wherein component (b) is selected from the group consisting of N-hydroxymethyl(meth)acrylamide, N-hydroxyethyl(meth)acrylamide, N-hydroxypropyl(meth)acrylamide, N,N-bis(hydroxyethyl)acrylamide, N,N-bis(hydroxypropyl)acrylamide and any mixture thereof, preferably component (b) is N-2-hydroxyethylacrylamide.

16. The dispersion according to claim 14, wherein at least one component containing an isocyanate group(s) and a (meth)acrylamide functional group(s) is used as component (b) (component (b2)).

17. The dispersion according to claim 14, wherein the polyurethane A is acryloyl amide functional, whereby the acrylamide functional groups are introduced into the polyurethane A by using at least one component containing an isocyanate group(s) and an acrylamide functional group(s) (component (b2)) as building block of the polyurethane A, which component (b2) is obtained in-situ before preparation of the urethane prepolymer by reacting in the presence of a catalyst an isocyanate compound having at least two isocyanate groups with acrylic acid.

18. The dispersion according to claim 17, wherein the anionic functionality of the polyurethane A is obtained by incorporating sulfonate groups into the polyurethane A.

19. The dispersion according to claim 1, wherein the polyurethane A is free of (meth)acryloyl ester functional groups.

20. The dispersion according to claim 1, wherein the dispersed particles have an average particle size of 10 nm or higher and of 200 nm or lower.

21. The dispersion according to claim 1, wherein the polyurethane A is present in an amount of from 10 to 50% by solids weight, based on the total solids weight of the dispersion.

22. Ink composition comprising the dispersion according to claim 1, wherein the amount of polyurethane A is in the range from 2 to 20 wt. %, relative to the total weight of the ink composition.

23. Use of an ink composition according to claim 22 for inkjet printing.
